(19) United States
(12) Patent Application Publication
(10) Pub. No.: US 2007/0253404 A1
(43) Pub. Date: Nov. 1, 2007

(54) Remote-dialing system and method thereof for saving call tolls

(76) Inventors: Hung-Peng Kang, Sindian City (TW); Yung-Tai Yang, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/410,889

(22) Filed: Apr. 26, 2006

(51) Int. Cl. H04L 12/66; H04L 12/56

(52) U.S. Cl. 370/352; 370/401

(57) ABSTRACT

A remote-dialing system and method thereof for saving call tolls, wherein the remote-dialing system comprises a first computer for executing a remote-dialing means and an Internet communicating means, a second computer for executing a controlling means and the Internet communicating means, and a telephone integrating device. The first computer and the second computer are connected to the Internet, and the telephone integrating device is connected to a public switched telephone network and further is connected to the second computer. Hence, through the transmission between the Internet and the public switched telephone network and the operation of the first computer, the second computer, and the telephone integrating device, people can dial a remote non-VoIP call without the Internet voice communication industries so as to save the call tolls.

### BACKGROUND OF THE INVENTION

1. Field of the Invention

The present invention relates to a remote-dialing system and method thereof for saving call tolls, and more particularly a remote-dialing system and method for saving call tolls adapted to a VoIP calls dialing to general telephones of a public switched telephone network.

2. Description of the Prior Art

A public switch telephone network (PSTN) that is used to transmit when the user communicate by telephone sets and the general telephone communication is mainly used in the same area. However, if the users want to have a long-distance call such as between Taiwan and the America, the communication that is converted by a telecommunication company and the users have to pay a higher expense. In contrast, an Internet is a cheaper communication path so that many communication industries gradually apply the communication technology to the Internet.

Reference is made to FIG. 1. A conventional Internet telecommunication system 1 is built on a structure of the voice over Internet protocol (VoIP). User of a first computer 11 and user of a second computer 12 mutually communicate via an Internet 2 due to the VoIP software. Both the users of the first computer 11 and the second computer 12 connect microphones and earphones to talk to each other; even VoIP phones are used today. The user of a first VoIP phone 13 and the user of a second VoIP phone 14 have a dialogue if the first VoIP phone 13 and the second VoIP phone 14 connected to the Internet. Hence, users only pay the expense of the Internet connection and the hardware. However, this kind of communication way is limited to the Internet. When one party uses the VoIP but the other party uses a local telephone 16 or a mobile phone 17, the connection that is converted by an Internet speech sound communication service provider 15. Hence, the users have to pay not only the expense of the local called party but also the call forwarding expense for the Internet speech sound communication service provider 15. In addition, if the users both locate in the same area, they can have a dialogue using the public switched telephone network without paying the call forwarding expense.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a remote-dialing system and method thereof for saving call tolls of using VoIP calls dialing to general telephones of a public switched telephone network. For achieving the objective state above, the present invention to provide a remote-dialing system and method thereof for saving call tolls, wherein the remote-dialing system comprises a first computer, a second computer and a first telephone integrating device. The first computer executes a remote-dialing means and an Internet communicating means and the second computer executes a controlling means and the Internet communicating means, and the first telephone integrating device is connected to the second computer and a first public switched telephone network where the second telephone integrating device located. When users execute the remote-dialing means by the first computer and dial to the first public switched telephone network where the second computer located through the Internet communicating means, the second computer receives a dialing request of the remote-dialing means to execute the controlling means to automatically dial to the first public switched telephone network. As a call is connected between the two parties, the first telephone integrating device transforms voice signals used by the first public switched telephone network into other voice signals that can be accepted by computers and the voice signals transformed by the second computer into voice data packets used by the Internet, and next the voice data packets mutually exchanged by the Internet. Hence, the transmission between the Internet and the public switched telephone network to have a dialogue with the two parties without by way of the Internet voice communication industries so as to save the call forwarding expense of using VoIP calls dialing to general telephones of a public switched telephone network.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a schematic view of an Internet telecommunication system structure of the prior art;

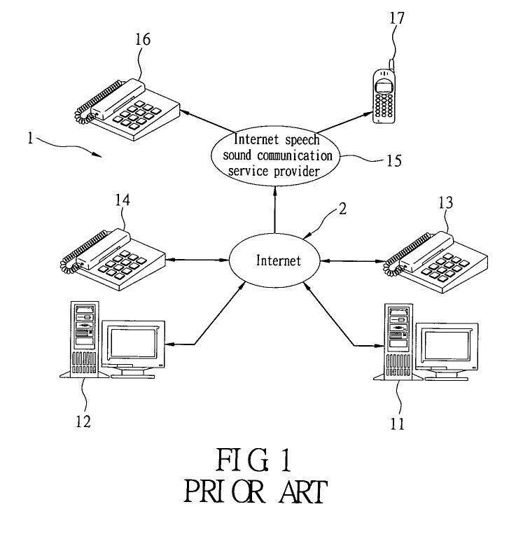

FIG. 2 is a schematic view of a remote-dialing system of the present invention;

FIG. 3 is a schematic view of another embodiment of the present invention;

FIG. 4 is a schematic view of a telephone integrating device structure of the present invention; and

FIG. 5 is flow chart of the remote-dial method of the present invention.

The drawings will be described further in connection with the following detailed description of the present invention.

### DETAILED DESCRIPTION OF THE PREFERRED EMBODIMENTS

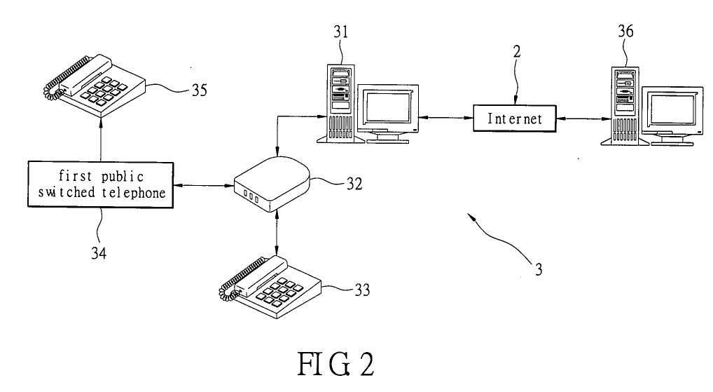

Reference is made to FIG. 2. The present invention provides a remote-dialing system 3 for saving call tolls of using VoIP calls dialing to general telephones of a public switched telephone network, that is the users of the two parties only pay the expense of their own local public switched telephone networks. The remote-dialing system 3 comprises a second computer 31, a first computer 36 and a first telephone integrating device 32. The second computer 31 is for executing a controlling means and an Internet communicating means, the first computer 36 is for executing a remote-dialing means and the Internet communicating means, and the second computer 31 and the first computer 36 are connected with an Internet 2. The first telephone integrating device 32 is connected to the second computer 31 by an USB transmission line and is connected to a first public switched telephone network 34 by a telephone line with a RJ-11 port, and further is connected to a first telephone set 33 by a telephone line with a RJ-11 port. When the user of the first computer 36 wants to have a dialogue with the user of the second computer 31, the user of the first computer 36 executes the Internet communicating means by the first computer 36 to send out a communicating request, and the user of the second computer 31 can talk to the user of the first computer 36 by directly using earphones or the first telephone set 33 is connected with the second computer 31. Similarly, the user of the second computer 31 can use the same way actively talk to the user of the first computer 36. On the other hand, the user of the first computer 36 send out a communicating request to the user of the second computer 31, if the user of the second computer 31 doesn't directly have a dialogue with the user of the first computer 36, the second computer 31 can execute the controlling means to have a call forwarding to a preset local telephone number or a mobile phone number so that the user of the second computer 31 doesn't miss the call.

If the user of the first computer 36 wants to dial to a first local telephone 35 of the first public switched telephone network 34, the user of the first computer 36 can execute the remote-dialing means by the first computer 36; the remote-dialing means sends out a dialing message to the second computer 31 by a interface of the Internet communicating means, and the second computer 31 receives the dialing message by the Internet communicating means and next executes the controlling means to send out a dialing message so that the first telephone integrating device 32 automatically dial to the first local telephone 35 by the first public switched telephone network 34. As a call is connected between the two parties, the first telephone integrating device 32 transforms the analog voice signals used by the first public switched telephone network 34 into the digital signals used by the USB port (transmission line) and transmits the digital signals to the second computer 31; or the first telephone integrating device 32 transforms the digital signals sent out from the second computer 31 and used by the USB port (transmission line) into the analog voice signals and transmits the analog voice signals to the first public switched telephone network 34. The second computer 31 exchanges the digital signals used by the USB port (transmission line) and the voice data packets used by the Internet, and separately transmits them to the first telephone integrating device 32 and the Internet 2. Hence, the user of the first computer 36 can have a dialogue with the user of the first local telephone 35 by the exchange of the packets of the Internet and the exchange of the voice signals of the public switched telephone network.

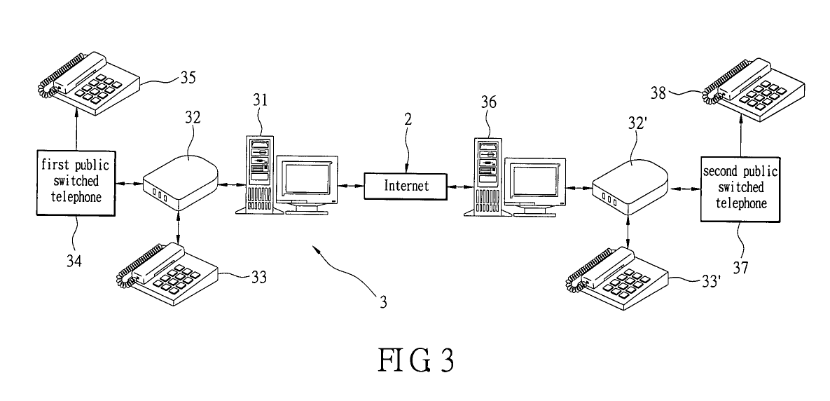

Reference is made to FIG. 3. In the embodiment, the first computer 36 is connected to a second telephone integrating device 32′; wherein the second telephone integrating device 32′ is a telephone integrating device same with the first telephone integrating device 32. The first telephone integrating device 32′ is connected to a second public switched telephone network 37 where the first computer 36 located, and further connected to a second telephone set 33′. The second computer 31 executes the remote-dialing means, the Internet communicating means, and the controlling means; the first computer 36 does, too. Hence, the user of the second computer 31 and user of the first computer 36 can mutually request to have a dialogue and the user of the first computer 36 can dial to the first local telephone 35, in addition, the user of the second computer 31 also dial to a second local telephone 38 of the second public switched telephone network 37.

Furthermore, if the user of the second computer 31 can't send out a communicating request to the user of the first computer 36 or wants to dial to the second local telephone 38, the user of the second computer 31 can first dial to a local telephone used the first public switched telephone network 34 that is connected to the first telephone integrating device 32 by a local telephone or a mobile phone if the user of the second computer 31 locates inside the area of the first public switched telephone network 34. Due to no answer, the second computer 31 will execute the controlling means to inform the user of the second computer 31 to leave a message or have a call forwarding. If the user of the second computer 31 chooses to have a call forwarding and dial to the user of the first computer 36 or the second local telephone 38, the second computer 31 executes the controlling means to request the user of the first computer 36 to have a dialogue or dial to the second local telephone 38 for talking. Similarly, the user of the first computer 36 can use the same way to request the user of the second computer 31 to have a dialogue or dial to the first local telephone 35.

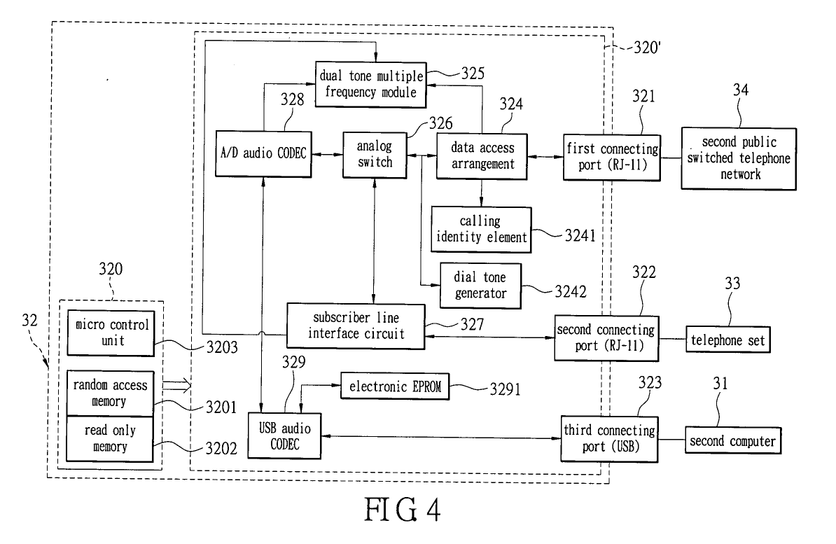

Reference is made to FIG. 4. The present invention provides the first telephone integrating device 32 for integrating the VoIP calls and the general telephones by connecting computers such as the second computer 31 and public switched telephone networks such as the first public switched telephone network 34. The first telephone integrating device 32 comprises a data access arrangement (DAA) 324, an analog switch 326, a subscriber line interface circuit (SLIC) 327, a A/D audio CODEC 328, a USB audio CODEC 329, a dual tone multiple frequency (DTMF) module 325, a first connecting port, a second connecting port, and s third connecting port. The first connecting port is a RJ-11 port 321 for connecting the first telephone integrating device 32 to the public switched telephone network, the second connecting port is another RJ-11 port 322 for connecting a telephone set such as the first telephone set 33, and the third connecting port for connecting to a USB port 323 of the computer.

The RJ-11 port 321 connected to the data access arrangement 324 by a tip and a ring, the data access arrangement 324 electrically connected to the analog switch 326 that further electrically connected to the subscriber line interface circuit 327 and the A/D audio CODEC 328 that further connected to the USB audio CODEC 329 and the subscriber line interface circuit 327 connected to the RJ-11 port 322, and the USB audio CODEC 329 connected to the USB port 323. Furthermore, the dual tone multiple frequency module 325 for detecting the analog video signals and information of the data access arrangement 324, the subscriber line interface circuit 327, and the A/D audio CODEC 328 so as to determine the analog video signals transmitted to the public switched telephone network, the telephone set, or the computers for controlling the switch path of the analog switch 326. If analog video signals transmitted from the public switched telephone network, the analog video signals can be detected by the dual tone multiple frequency module 325 to determine a source of the signals so as to further drive a calling identity element 3241 by the data access arrangement 324. On the other hand, if the signals transmitted to the public switched telephone network, the data access arrangement 324 drives a dial tone generator 3242 to imitate the dial tone. Furthermore, the first telephone integrating device 32 further comprises a controlling element 320 for accessing controlling data to control the first telephone integrating device 32. The controlling element 320 consisted of a micro control unit (MCU) 3203, a random access memory (RAM) 3201, and a read only memory (ROM) 3202. An electronic EPROM 3291 connected to the USB audio CODEC 329 for accessing the data thereof.

When the first telephone integrating device 32 receives a dialing signal from the public switched telephone network, firstly, the signal that is inputted by the RJ-11 port 321 and next transmitted to the data access arrangement 324, at this time, the dual tone multiple frequency module 325 will detect the signal and determine the sending-out number of the signal and transmitted to the telephone set. Moreover, the data access arrangement 324 drives the calling identify element 3241 to produce a caller ID, and controls the analog switch 326 to switch a path communicated between the data access arrangement 324 and the subscriber line interface circuit 327. And next the signal transmitted to the subscriber line interface circuit 327 via the analog switch 326, and next transmitted to the RJ-11 port 322. On the other hand, if users want to dial from the telephone set to the public switched telephone network, the dialing signal of the telephone set transmitted to the first telephone integrating device 32, and the signal transmitted to the subscriber line interface circuit 327 by the RJ-11 port 322. At this time, the dual tone multiple frequency module 325 detects the signal of the subscriber line interface circuit 327 to determine that the signal transmitted to the public switched telephone network, controls the analog switch 326 to switch a path communicated between the data access arrangement 324 and the subscriber line interface circuit 327. And next the signal transmitted to the data access arrangement 324, and the dual tone multiple frequency module 325 identifies the telephone number that is desired to be transmitted when the data access arrangement 324 detects the signal again, and next the data access arrangement 324 drives the dial tone generator 3242 to imitate the dial tone so as to dial to the telephone number.

In addition, if a dialing signal transmitted from remote end via the Internet, firstly, the signal received by a computer and next transmitted to the USB port 323 by an USB transmission line, and next transmitted into the first telephone integrating device 32. Moreover, the signal transmitted to the USB audio CODEC 329 and the original USB signal converted into general digital signal by the USB audio CODEC 329. And next, the digital signal transmitted to the A/D audio CODEC 328 and interpreted into the analog signal, and next the dual tone multiple frequency module 325 will detect the analog signal and determine the signal that is transmitted to the telephone set of the first telephone integrating device 32 or the public switched telephone network. If the former, the dual tone multiple frequency module 325 controls the analog switch 326 to switch a path communicated to the telephone set; if the latter, the dual tone multiple frequency module 325 controls the analog switch 326 to switch a path communicated to the public switched telephone network. When the signal transmitted to the data access arrangement 324 and detected by the dual tone multiple frequency module 325, the data access arrangement 324 drives the dial tone generator 3242 to imitate the dial tone so as to dial to the public switched telephone network.

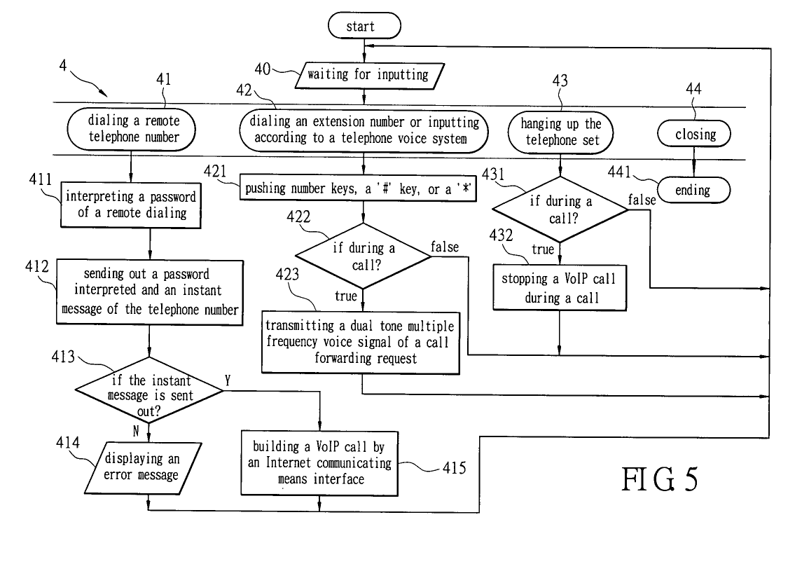

Reference is made to FIG. 5. The present invention provides a remote-dialing method 4, comprises the steps of: waiting for inputting 40, dialing a remote telephone number 41, dialing an extension number or inputting according to a telephone voice system 42, hanging up a telephone set 43, and closing 44. In the step of waiting for inputting 40, when dialing a remote telephone number, the users first input a password and the telephone number, and next the password that is interpreted 411, and next the password and an instant message of the telephone number that are transmitted 412, and next determines the instant message whether is sent out or not 413: if “false”, displaying an error message 414 and directly returning to the step of waiting for inputting 40; if “true”, building a VoIP call by an Internet communicating means interface 415 so that the users are ready to communicate, and returning to the state of waiting for inputting 40 to wait for a new input.

In addition, dialing an extension number or inputting according to a telephone voice system 42, that is when a remote dial-in telephone message received, the call party can choose to leave a message or have a call forwarding if no answer. If the call party chooses to have a call forwarding and pushes number keys, a ‘#’ key, or a ‘*’ key 421 to forward to an internal extension number or other telephone numbers, the system determines the call forwarding whether during a call or not 422: if “true”, transmitting a dual tone multiple frequency voice signal of the call forwarding request 423; if “false”, having a call from the called party and next returning to the state of waiting for inputting 40. Hanging up the telephone set 43 is to determine the call forwarding whether during a call or not 431 when users hang up the telephone set: if “true”, stopping the VoIP call during a call 432; if “false”, continuing to waiting for inputting 40. Finally, closing 44 is to end entire procedure 441.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A remote-dialing system for integrating VoIP calls and general telephones through a transmission between the Internet and public switched telephone networks for saving call tolls, comprising:
a first computer connected with the Internet;
a second computer, a remote computer of the first computer, also connected with the Internet;
means executed through the first computer for remote-dialing a first public switched telephone network where the second computer located;
means executed through the first computer and the second computer for communicating both users of the first computer and the second computer via the Internet;
means executed through the second computer for controlling the second computer for transferring the remote dialing of the first computer; and
a first telephone integrating device connected with the second computer and the first public switched telephone network for transferring the transmitting signals between the Internet and the first public switched telephone network.

2. The remote-dialing system as in claim 1, wherein the first telephone integrating device connected with the second computer by means of a USB transmitting line.

3. The remote-dialing system as in claim 1, wherein the first telephone integrating device connected with the first public switched telephone network by means of a RJ-11 telephone line.

4. The remote-dialing system as in claim 1, wherein the first telephone integrating device connected with a first telephone set by means of a RJ-11 telephone line.

5. The remote-dialing system as in claim 4, wherein the first telephone set is a wire telephone set or a wireless telephone set.

6. The remote-dialing system as in claim 1, further comprising a second telephone integrating device connected with the first computer and a second public switched telephone network for transferring transmission signals between the Internet and the second public switched telephone network, wherein the means executed through the first computer for controlling and the means executed through the second computer for remote-dialing.

7. A telephone integrating device for serially connecting computers connected on the Internet and the public switched telephone networks for integrating VoIP calls and general telephones, comprising:
a data access arrangement installed in the telephone integrating device for detecting line status of a received terminal on the public switched telephone network and exchanging voice signals on the public switched telephone network;
an analog switch electrically connected with the data access arrangement for switching channels of the voice signals;
a subscriber line interface circuit connected with the analog switch for detecting hanging-up status and exchanging the voice signals with telephone set;
an A/D audio CODEC connected with the analog switch for mutually transforming the analog voice signals and the digital voice signals;
an audio CODEC connected with the A/D audio CODEC for transforming the digital voice signals to acceptable voice signals for computers;
a dual tone multiple frequency module for detecting the voice signals of the data access arrangement, the subscriber line interface circuit, and the A/D audio CODEC;
a first connecting port electrically connected with the data access arrangement and further connected with the local public switched telephone network;
a second connecting port electrically connected with the subscriber line interface circuit and further connected with a telephone set; and
a third connecting port electrically connected with the audio CODEC and further connected with a computer.

8. The telephone integrating device as in claim 7, wherein the first connecting port and the second connecting port are both RJ-11 ports.

9. The telephone integrating device as in claim 7, wherein the third connecting port is an USB port.

10. The telephone integrating device as in claim 7, wherein the audio CODEC is an USB audio CODEC for mutually transforming the voice signals transmitted by means of an USB transmission line with the digital voice signals.

11. The telephone integrating device as in claim 7, further comprising:
a calling identity element connected with the data access arrangement;
a dial tone generator for producing dial tone emulation;
an electronic EPROM connected with the audio CODEC for accessing data of the audio CODEC; and
a controlling element for accessing controlling data to control the telephone integrating device.

12. The telephone integrating device as in claim 11, wherein the controlling element formed with a micro controlling unit, a random access memory (RAM), and a read only memory (ROM).

13. A remote-dialing method for saving call tolls, comprising the steps of:
waiting for inputting;
dialing a remote telephone number;
interpreting a password of dialing the remote telephone number;
sending the password and an instant message of dialing the remote telephone number;
determining whether the instant message sent out or not; and
building a VoIP call through means for Internet communicating if the instant message sent out.

14. The remote-dialing method for saving call tolls as in claim 13, wherein showing an error message if the instant message is not sent out.

15. The remote-dialing method for saving call tolls as in claim 13, wherein following steps of waiting for inputting further comprising:
dialing an extension number or inputting according to a telephone voice system;
pushing number keys, a ‘#’ key or a ‘*’ key;
determining whether during a calling or not;
transmitting a dual tone multiple frequency voice signal of a call forwarding if during the call; and
returning the step of waiting for inputting.

16. The remote-dialing method for saving call tolls as in claim 13, wherein the step of determining whether during a calling or not, if not during a call, then step to the step of returning the step of waiting for inputting.
